(19) United States
(12) Patent Application Publication
(10) Pub. No.: US 2014/0166613 A1
(43) Pub. Date: Jun. 19, 2014

(54) STRUCTURING OF ANTISTATIC AND ANTIREFLECTION COATINGS AND OF CORRESPONDING STACKED LAYERS

(71) Applicants: Oliver Doll, Dietzenbach (DE); Ingo Koehler, Reinheim (DE); Christian Matuschek, Frankfurt am Main (DE); Werner Stockum, Reinheim (DE)

(72) Inventors: Oliver Doll, Dietzenbach (DE); Ingo Koehler, Reinheim (DE); Christian Matuschek, Frankfurt am Main (DE); Werner Stockum, Reinheim (DE)

(73) Assignee: MERCK PATENT GMBH, Darmstadt (DE)

(21) Appl. No.: 14/233,464

(22) PCT Filed: Jun. 19, 2012
(86) PCT No.: PCT/EP2012/002569

§ 371 Date: Jan. 17, 2014

(30) Foreign Application Priority Data
Jul. 18, 2011 (EP) 11005862.5

(51) Int. Cl. H01B 13/00

(52) U.S. Cl. CPC H01B 13/00
USPC 216/13; 252/79.1

(57) ABSTRACT

The present invention relates to compositions which are particularly suitable for the etching and structuring of transparent, conductive antireflection coatings and of corresponding stacked layers, which are preferably present in touch-sensitive display screens or display elements. The latter are generally also known as touch-sensitive displays, touch panels or touch screens. In particular, these are compositions by means of which fine structures can be etched selectively into conductive transparent oxidic layers and into corresponding layer stacks.

The present invention relates to novel screen-printable or dispensable homogeneous compositions having non-Newtonian flow behaviour which are particularly suitable for the etching and structuring of oxidic transparent or oxidic, transparent, conductive antireflection coatings and of corresponding stacked layers, which are preferably present in touch-sensitive display screens or display elements. The latter are generally also known as touch-sensitive displays, touch panels or touch screens. In particular, these are compositions by means of which fine structures can be etched selectively into conductive transparent oxidic layers and into corresponding layer stacks.

Corresponding oxidic layer structures and the structuring thereof are, for example, also necessary for the production of liquid-crystal displays (LCDs), organic light-emitting displays (OLEDs), thin-film solar cells and modules, and, as already stated, of touch-sensitive and thus, for example, command-transmitting electrical and electronic display elements (for example touch panels and touch screens [these terms are used synonymously below for this type of electronic components]).

### PRIOR ART

In general, modern input and output devices, in particular those for private use, have so-called touch screens. These are touch-sensitive display screens, which are also known as touch panels. By touching parts of an image on the screen, the program execution of a technical device, usually a computer, is controlled directly. Mobile telephones, tablet PCs and other display devices can be fitted therewith. The touch-sensitive display screens are usually liquid-crystal displays. The term touch-sensitive LC displays is therefore used below.

An LC display essentially consists of two glass plates provided with conductive, transparent oxidic layers, usually indium tin oxide layers (ITO layers). A liquid-crystal layer which changes its light transmission through application of a voltage is located between the thin coated glass plates. The ITO front and back are prevented from touching by the use of spacers. For the display of characters, symbols or patterns, it is necessary to structure the transparent conductive layer on the glass sheet. Only through structuring does it become possible to select areas within the display selectively.

The glass sheets and/or plastic or polymer films used for display manufacture, preferably those made from polyethylene terephthalate (PET), usually have an ITO layer thickness on one side in the range from 20 to 200 nm, in most cases in the range from 30 to 130 nm. In the following context, even if not mentioned explicitly, support materials for inorganic surfaces defined at the outset are taken to mean materials which comply with the definition made above: i.e. represent either glass sheets and/or polymer films, preferably, but not exclusively, those made from PET and/or polyethylene naphthalene dicarboxylate (PEN).

As an alternative to the use of indium tin oxide as oxidic, transparent, conductive material, the use and thus the substitution thereof by FTO (fluorine-doped tin oxide) is possible and is attractive from cost points of view owing to the considerable increase in the raw-material price of indium. FTO belongs to the first generation of transparent, conductive oxides which can be produced on a large industrial scale. Corresponding deposition technologies and production methods are very well known for this reason. Thus, FTO can be deposited, for example, very cost-efficiently on glass substrates by means of pyrolytic methods. Substrates having relatively low temperature stability can be provided with FTO, for example by means of CDV (chemical vapour deposition).

In the course of display manufacture, the transparent conductive layer on the glass sheets is structured in a plurality of process steps. The process of photolithography, which is known to the person skilled in the art, is employed for this purpose.

Inorganic surfaces in the present description are taken to mean oxidic compounds which, through the addition of a dopant, either have increased electrical conductivity and retention of the optical transparency or, with omission of the said doping, are otherwise capable of the formation of thin functional layers, which can be part of an overall system, which may itself consist of a sequence of a plurality of, in a particular manner also alternating, inorganic surfaces. These include the layer systems known to the person skilled in the art comprising:
indium tin oxide In₂O₃:Sn (ITO)
fluorine-doped tin oxide SnO₂:F (FTO)
antimony-doped tin oxide SnO₂:Sb (ATO)
aluminium-doped zinc oxide ZnO:Al (AZO)
boron-doped zinc oxide
gallium-doped zinc oxide (GZO)

The deposition of indium tin oxide by cathode sputtering is known to the person skilled in the art.

ITO layers having adequate conductivity can also be obtained by wet-chemical coating (sol-gel dip process) using a liquid or dissolved solid precursor in a solvent or solvent mixture. These liquid compositions are usually, but not exclusively, applied by spin coating to the substrate to be coated. Alternative deposition methods which may be mentioned by way of example are roller printing and slot-nozzle coating. These compositions are known to the person skilled in the art as spin-on-glass (SOG) systems.

The use of oxidic, transparent and oxidic, transparent, conductive layers (inorganic surfaces) is not restricted exclusively to the formation of suitable electrodes on inert support materials (cf. above definition). The literature describes such layers or layer stacks thereof in some cases as functional constituents of above-mentioned components, which can serve the purpose of reflection reduction (antireflection layers) of touch screens. Layers of oxidic materials of comparatively high refractive index (n), such as, for example, consisting of Nb₂O₅ (n=2.37), ZrO₂ (2.06), Y₂O₃, HfO₂, Sc₂O₃, Ta₂O₅ (n=2.17), Pr₂O₃, Al₂O₃ and/or TiO₂ (2.45) and ITO (n˜2.0) and mixtures of the said materials, in some cases in combination with interlayers consisting of materials of comparatively low refractive index, such as SiO₂ (n=1.47), SiNₓ and/or SiNₓO_{y}, with retention of a high degree of transmission can be used for this purpose (cf., for example, U.S. Pat. No. 7,724,241, B2; US 2007/0166522 A1; US 2010/0065342; TW 20090140990; D. R. Gibson, I. Brinkley, E. M. Waddell, XYZ,). In addition, layer sequences (layer stacks) of the oxidic materials enumerated can be used for the production of antireflective and antistatic units in the production of touch panels (C. Haixing, H. Yuyong, X. Xuanqian, B. Shengyuan, Chinese Optical Letters, 8, 2010, 201).

The literature describes Nb₂O₅ as an unusual material: on the one hand, it is described as a ceramic material, which, however, can have a bulk conductivity approximately equal to that of normal metals. Furthermore, it forms very stable, qualitatively high-quality dielectric films (W. Millman, T. Zednicek, Niobium Oxide Capacitors Brings High Performance to a Wide Range of Electronic Applications, Proceedings of the Electronic Components Industry Association, CARTS Europe 2007).

However, a touch-sensitive display has better quality the less the incident light is reflected and the more light is transmitted by the layers which can be activated electrically by touch, including the flexible polymer layer.

Owing to its advantageous properties in this respect and its conductivity, Nb₂O₅ layers are of ever-increasing importance in the production of corresponding electronic components. This applies, in particular, to the production of touch-sensitive display screens, especially as Nb₂O₅ layers have proven to be stable on flexible layers. Coatings comprising Nb₂O₅/SiO₂ also have these advantageous properties in the production and use of such display screens. Nb₂O₅ and Nb₂O₅/SiO₂ coatings are therefore of ever-increasing importance. Depending on the area of application and depending on the external conditions, such as temperature and the like, these coatings are thus in competition with SiO₂/TiO₂ or fluorine-doped tin oxide layers (FTO layers), which can be employed for the same purpose. Compared with TiO₂ layers, Nb₂O₅ layers have better conductivity. The use of Nb₂O₅ as replacement for the TiO₂ conventionally used as electrode material in dye-sensitised solar cells is therefore being discussed in the literature (Le Viet et. Al. J. Phys. Chem. C 2010, 114, 21795-21800; “Nb₂O₅ Photoelectrodes for Dye-Sensitised Solar Cells: Choice of the Polymorph”).

US 2009/0188726 A1 describes a touch panel having improved transmittance and reduced reflection which has transparent, conductive antireflection coatings and corresponding stacked layers, in which transparent conductive layers of high and low refractive index are combined with one another. Layers of oxides of niobium, titanium, tantalum, zirconium, silicon and magnesium or corresponding mixed oxides can be combined with one another in the stacked layers in such a way that the reflection is reduced by a combination of layers of different refractive index. In this combination, the refractive indices of the flexible substrate layer and a layer of air are incorporated between the first and second transparent conductive oxide layers.

U.S. Pat. No. 7,724,241 B2 also employs Nb₂O₅ layers in order to reduce the reflection as a conductive layer of high refractive index.

However, it is not only the properties with respect to reflection and refraction of light that are of importance for the usability of such layers in touch-sensitive displays. The surface nature and the stability of the support material on bending are also of importance. Nb₂O₅ layers have also proven suitable in this respect, meaning that layers of this type are increasingly being used in modern equipment.

On the other hand, it may appear necessary during the production of touch panels for either the antireflective layer stacks or the antireflective and anti-static layer stacks to have the coating removed in the edge region, for example in subsequent process steps, preferably before encapsulation thereof into the entire finished component. Coating removal in this connection is taken to mean the removal of the oxidic layer stack from the back support material.

In addition, corresponding layer stacks must, in order to be able to function correctly in corresponding touch-sensitive displays, be structured in such a way that the signal arising due to touching can be localised on the display and can be processed by the computer program.

As an alternative to photolithography, structuring with the aid of a laser beam has become established as a process in recent years.

In laser-supported structuring processes, the areas to be removed are scanned the laser beam point by point or line by line in a vector-oriented system. At the points scanned by the laser beam, the inorganic surfaces are evaporated spontaneously by the high energy density of the laser beam (ablation). The process is fairly suitable for the structuring of simple geometries. It is less suitable in the case of more complex structures and especially in the case of the removal of relatively large areas of the said inorganic surfaces.

In some applications, such as, for example, the structuring of transparent conductive layers for OLED displays, the laser structuring is basically unsuitable: evaporating transparent conductive material precipitates in the immediate vicinity on the substrate and increases the layer thickness of the transparent conductive coating in these edge regions. This is a considerable problem for the other process steps, in which the flattest possible surface is required.

An overview of various etching processes is given in

[1] D. J. Monk, D. S. Soane, R. T. Howe, Thin Solid Films 232 (1993), 1;

[2] J. Bühler, F.-P. Steiner, H. Baltes, J. Micromech. Microeng. 7 (1997), R1

[3] M. Köhler “Ätzverfahren für die Mikrotechnik” [Etching Processes for Microtechnology], Wiley VCH 1983.

The disadvantages of the etching processes described lie in the time- and material-consuming, expensive process steps, which are in some cases complex in technological and safety terms and are frequently carried out discontinuously.

According to information from the literature, Nb₂O₅ can be etched using acids, such as, for example, sulfuric acid, hydrochloric acid and also acid mixtures consisting of hydrofluoric acid and nitric acid (Handbook of Metal Etchants, CRC Press, 1991, Editors: P. Walker, W. H. Tran). Alkaline etchants are not described; by contrast, Nb₂O₅ is described as stable to water and non-complexing alkalis. In the melt, Nb₂O₅ can be etched using alkali metal carbonates. This stability is evident, inter alia, in the Pourbaix diagram depicted as FIG. 1.

### OBJECTIVE

The object of the present invention is therefore to provide a novel, inexpensive and simple process by means of which transparent conductive layers of Nb₂O₅— and Nb₂O₅/SiO2, SiO₂/TiO₂— or fluorine-doped TiO₂ (FTO), ITO, applied to a support material (glass or silicon layer) can be etched for the production of OLED displays, touch screens, TFT displays or thin-film solar cells. It is thus also an object of the present invention to provide novel, inexpensive etching pastes for the etching of inorganic layers. After the etching under the action of heat, it should be possible to remove these novel etching media from the treated surfaces in a simple manner without leaving residues.

### DESCRIPTION OF THE INVENTION

The present invention relates to a process for the etching and structuring of antistatic coatings and of antireflection coatings, and of corresponding oxidic, transparent layer stacks, which is characterised in that an alkaline etching composition is applied selectively to the surface to be treated, and the etching composition is activated by the input of energy, and, when the etching is complete, residues of the etching composition are removed using solvents, preferably using water.

Unexpectedly, the present process enables layers, optionally stacked layers of oxidic, transparent Nb₂O₅— and Nb₂O₅/SiO2, SiO₂/TiO₂— or fluorine-doped tin oxide (FTO), ITO layers (indium tin oxide) to be etched in one step without the underlying substrate being etched at the same time. Good results are achieved in the process by means of alkaline etching pastes which have a viscosity in the range from 5 to 100 Pa*s, preferably 5 to 50 Pas, at a shear rate of 25 s⁻¹, which is applied in accordance with the invention to the surfaces to be etched by the dispenser technique or by screen printing.

The etching step is carried out at a temperature in the range from 80 to 270° C., particularly preferably range from 100 to 250° C. Surprisingly good results are achieved through the use of an etching composition which comprises an alkaline etchant selected from the group KOH and NaOH and has non-Newtonian flow behaviour. The alkaline etchant is present in this particularly suitable etching composition in an amount of 30 to 45% by weight, preferably in an amount of 33 to 40% by weight, particularly preferably in an amount of 35 to 37% by weight. In addition, the etching composition comprises solvents in an amount of 30 to 70% by weight, preferably in an amount of 35 to 65% by weight, particularly preferably in an amount of 53-62% by weight. Good etching results are achieved using corresponding etching compositions which comprise thickeners in an amount of 1 to 20% by weight, preferably in an amount of 1 to 15% by weight, particularly preferably in an amount of 1-10% by weight.

### DETAILED DESCRIPTION OF THE INVENTION

The present invention relates to a novel, homogeneous etching medium having non-Newtonian flow behaviour which is either screen-printable or dispensable for the etching of oxidic transparent and oxidic transparent conductive layers and layer stacks, for example for the production of liquid-crystal displays (LCDs), organic light-emitting displays (OLEDs), thin-film solar cells and modules and that of touch-sensitive and thus, for example, command-transmitting electrical and electronic display elements (for example touch panels and touch screens.

Experiments have now shown that the use of selected thickeners in the presence of alkaline etchants and, if necessary, the addition of particulate additives enables the preparation of pastes which are able to etch the inorganic surfaces defined above. As a consequence of the selection of the added components necessary for the paste formulation, a pseudoplastic and/or thixotropic gel-like network can be formed by chemical interactions with the other constituents of the etching medium. These novel gelatinous pastes exhibit particularly excellent properties for paste application, either by means of the dispenser technique or screen printing, depending on their individual formulation.

Given a suitable choice of the added, thickening components, for example gel formers, it may even be possible to completely omit the addition of a particulate additive, which is usually suspended homogeneously in known particle-containing pastes.

The object according to the invention is thus achieved by the provision of a novel printable etching medium having non-Newtonian flow behaviour in the form of an etching paste for the etching of the inorganic surfaces defined above. These pastes according to the invention comprise, if necessary, thickeners and particulate additives consisting of a material which is selected from the group of functionalised polyacrylic acids and derivatives, and copolymers thereof, carboxymethylcelluloses, fluorinated polymers (PTFE, PVDF, inter alia), and micronised waxes, such as, for example, polypropylene and functionalised derivatives thereof, polyethylene and functionalised derivatives thereof, homologous relatively long-chain polyolefins, and functionalised and non-functionalised copolymers thereof, micronised waxes mentioned above, the surfaces of which have been subjected to post-oxidative treatment after preparation, silicatic silicates, inosilicates, chain silicates, phyllosilicates and tectosilicates, nano- to microscale, oxidic, ceramic particles, silicon carbide, boron nitride, silicon nitride, inert salts which have been powdered to a microscale and are insoluble in the liquid phase.

Besides other components, the etching pastes according to the invention necessarily comprise at least one etching component, at least one solvent, at least one thickener, and optionally additives, such as antifoams, thixotropic agents, flow-control agents, deaerators and adhesion promoters.

The etching component present is an alkaline etchant, preferably KOH or NaOH. Compositions according to the invention comprise alkaline etchant in an amount of 30 to 45% by weight, preferably in an amount of 33 to 40% by weight. Particularly good etching results are found if the etchant is present in the composition in an amount of 35 to 37% by weight.

The etchant present is usually dissolved in at least one solvent. Suitable solvents are water and in particular short-chain alcohols having up to 8 C atoms, such as, for example, methanol, ethanol, propanol, butanol and isomers thereof. However, polyalcohols, such as, for example, glycol, glycerol, butanediol, dihydroxypropyl alcohol, or polyethylene glycol and the like, may also be added as solvent. In this connection, high-boiling alcohols are highly suitable if etching is carried out at high temperatures. In addition, however, other suitable solvents may also be present in the composition. In total, solvents may be present in the compositions in an amount of 30 to 70% by weight. Solvents are preferably present in the compositions in an amount of 35 to 65% by weight, and particularly preferably in an amount of 53-62% by weight.

Besides etchants and solvents, the compositions comprise the above-mentioned thickeners. They may be present in an amount of 1 to 20% by weight. They are preferably added in an amount of 1 to 15% by weight. Particularly good etching results are achieved if thickeners are present in an amount of 1-10% by weight.

Apart from the components that are absolutely necessary, additives for improving the printing and etching results may furthermore be present in the etching-paste compositions. These can be surfactants, antifoams, and the like. Such additives may be present in an amount of 0.1 to 6% by weight, preferably 0.5 to 3% by weight.

The etching medium according to the invention is effective at low temperatures, i.e. at temperatures in the range from 15 to 50° C. It can also be activated, if desired, by the input of energy. It is preferably employed at elevated temperatures in order to accelerate the etching operation, so that the etching can be carried out with high throughput. The etching is therefore preferably carried out at temperatures in the range from 80 to 270° C., particularly preferably in the range from 100 to 250° C.

In accordance with the invention, the novel etching pastes having thixotropic, non-Newtonian properties are used to structure in a suitable manner oxidic, transparent and/or conductive layers, as defined above, in the process for the production of products for OLED displays, touch panels or screens, or touch-sensitive display screens, LC displays or for photovoltaics, semiconductor technology, high-performance electronics, solar cells or photodiodes.

To this end, the paste is printed onto the surface to be etched by a suitable method in a single step and removed again after a prescribed exposure time.

In this way, the surface is etched and structured at the printed points, while non-printed areas retain the original state.

The surface to be etched can be an area or part-area of oxidic, transparent and/or conductive material, as described as suitable above, and/or an area or part-area of a corresponding porous and non-porous layer of oxidic, transparent and/or conductive material on a support material.

A suitable printing technology process with a high degree of automation and high throughput is used for the transfer of the etching paste to the substrate surface to be etched. In particular, the dispenser technique and the screen, template, pad and stamp printing processes are known to the person skilled in the art as suitable printing processes for this purpose. Manual application is likewise possible.

Depending on the dispenser technique, screen, template, blanket or stamp design or reservoir selection, it is possible to apply the printable, homogeneous etching pastes having non-Newtonian flow behaviour which are described in accordance with the invention to the entire area or selectively in accordance with the etching structure pattern only at the points at which etching is desired. All masking and lithography steps which are otherwise necessary are thus superfluous. The etching operation can be carried out with or without the input of energy, for example in the form of thermal radiation (using IR emitters).

The actual etching process is subsequently terminated by washing the surfaces with water and/or a suitable solvent. To be precise, the printable, etching pastes having non-Newtonian flow behaviour are rinsed off the etched areas using a suitable solvent when the etching is complete.

The use of the etching pastes according to the invention thus enables large numbers of pieces to be etched inexpensively on an industrial scale in a suitable, automated process.

In a preferred embodiment, the etching paste according to the invention has a viscosity, depending on the shear rate range of, for example, 25 s⁻¹, in the range from 5 to 100 Pa*s, preferably 5 to 50 Pas. The viscosity here is the material-dependent proportion of the frictional resistance which counters the movement when adjacent liquid layers are displaced. According to Newton, the shear resistance in a liquid layer between two sliding surfaces arranged parallel and moved relative to one another is proportional to the velocity gradient or shear gradient G. The proportionality factor is a material constant, which is known as the dynamic viscosity and has the dimension mPa*s. In the case of Newtonian liquids, the proportionality factor is pressure- and temperature-dependent, but is independent of the shear rate or shear gradient acting on the liquid. The degree of dependence is determined by the material composition.

The more pronounced pseudoplastic (dependence of the dynamic viscosity on the shear rate acting) or thixotropic properties of the etching paste have a particularly advantageous action for screen or template printing and result in considerably improved results.

For the preparation of the media according to the invention, the solvents, etching components, thickeners and additives are mixed with one another successively and stirred for a sufficiently long time until a viscous paste having pseudoplastic and/or thixotropic properties has formed. The stirring can be carried out with warming to a suitable temperature. The components are usually stirred with one another at room temperature.

The components present are combined with one another in the etching pastes prepared in this way in such a way that storage-stable compositions are present which the customer can employ directly in the process even after a storage time of several weeks to several months without a loss of quality, if necessary after brief stirring.

Preferred uses of the printable etching pastes according to the invention arise for the processes described for the structuring of transparent conductive layers of Nb₂O₅ and Nb₂O₅/SiO₂, SiO₂/TiO₂ or fluorine-doped tin oxide (FTO), ITO, applied to a support material (glass or silicon layer) for the production of OLED displays, touch screens, TFT displays or thin-film solar cells.

In accordance with the present invention, it has proven particularly advantageous that the transparent, conductive layer stacks can be specifically etched and structured together with the aid of the etching-paste compositions according to the invention, where the etching operation is terminated after these layer stacks have been etched through, so that the light-transmitting substrate, preferably glass, retains its light transmission.

The pastes used in accordance with the invention can be applied by means of the dispenser technique. In this, the paste is introduced into a plastic cartridge. A dispenser needle is screwed onto the cartridge. The cartridge is connected to the dispenser control via a compressed-air tube. The paste can then be forced through the dispenser needle by means of compressed air. In this way, the paste can be applied as a fine line to a substrate, for example an ITO-coated glass. Depending on the choice of the needle internal diameter, paste lines of various width can be produced.

A further possibility for paste application is screen printing and/or template printing.

For application of the pastes to the areas to be treated, the etching pastes can be pressed through a fine-meshed sieve which contains the printing template. The sieve can be an etched metal sieve.

If the etching paste is applied by the screen-printing process using the thick-layer technique, as is generally carried out in the case of conductive metal pastes, the pastes can subsequently be baked, enabling the electrical and mechanical properties to be fixed. On use of the etching pastes according to the invention, the baking (firing through the dielectric layers) can instead also be omitted, and the applied etching pastes can be washed off after a certain exposure time using a suitable solvent or solvent mixture. The etching operation is terminated by the washing-off.

In order to carry out the process according to the invention for the etching and structuring of N₂O₅ or Nb₂O₅/SiO₂ layers or other transparent, conductive layer stacks, the novel alkaline etching paste is thus applied to the surface to be etched by a dispenser or screen-printing process. Although the etching operation can also be carried out without warming, it is possible, for activation and acceleration of the etching step, to heat the printed area by the input of energy, for example in the form of thermal radiation (using IR emitters).

The present description enables the person skilled in the art to use the invention comprehensively. Even without further comments, it is therefore assumed that a person skilled in the art will be able to utilise the above description in the broadest scope.

If anything is unclear, it goes without saying that the cited publications and patent literature should be consulted. These documents are accordingly regarded as part of the disclosure content of the present description.

### EXAMPLES

For better understanding and in order to illustrate the invention, examples are given below which are within the scope of protection of the present invention. These examples also serve to illustrate possible variants. Owing to the general validity of the inventive principle described, however, the examples are not suitable for reducing the scope of protection of the present application to these alone.

It furthermore goes without saying to the person skilled in the art that, both in the examples given and also in the remainder of the description, the component amounts present in the compositions always only add up in total to 100% by weight or mol %, based on the composition as a whole, and cannot exceed this, even if higher values could arise from the per cent ranges indicated. Unless indicated otherwise, % data are therefore regarded as % by weight or mol %, with the exception of ratios, which are reproduced in volume data.

The temperatures given in the examples and description and in the claims are always in ° C.

### Example 1

Etching paste consisting of homogeneous thickener

8 g of Carbomer are added to a solvent mixture consisting of:

205 g of potassium hydroxide solution, 47%

12 g of tripropylene glycol monomethyl ether

2.5 g of polydimethoxysilane

35 g of water

with stirring, and the mixture is stirred for a further 2 hours. The paste, which is now ready to use, can be printed by means of template printing.

### Example 2

Etching paste consisting of homogeneous thickener

8 g of Carbomer are added to a solvent mixture consisting of:

205 g of potassium hydroxide solution, 47%

12 g of tripropylene glycol monomethyl ether

2.5 g of polydimethoxysilane

35 g of water

with stirring, and the mixture is stirred for a further 2 hours. 4 g of a micronised polypropylene wax are subsequently added, and 1.7 g of a 30% poly-acrylic acid dispersion are also added. The mixture is homogenised for 30 minutes with vigorous stirring. The paste, which is now ready to use, can be printed by means of template printing.

### Example 3

Etching paste comprising homogeneously distributed thickener 5 g of Carbomer, 15 g of micronised polypropylene wax and 7 g of bentonite are added to a solvent mixture consisting of:

80 g of potassium hydroxide solution, 47% 6 g of 1,4-butanediol

with stirring. The mixture is stirred vigorously for 2 hours until a homogeneous composition forms.

### Example 4

A paste according to Example 3 is applied to a glass substrate with an Nb₂O₅ layer with a thickness of 25 nm using a hand coater. The wet-film thickness is 20 μm. The substrate is treated at 100° C. on a hotplate for 1 minute. The paste is subsequently removed from the surface using a water jet, and the etching is characterised using a tactile surface profilometer. (FIG. 2)

### Example 5

A paste prepared in accordance with Example 3 is printed onto a glass substrate coated with an Nb₂O₅ layer with a thickness of 25 nm and an SiO₂ layer with a thickness of 100 nm in a line width of 100 μm using a screen printer (30 μm wet-film thickness). The printed sample is treated at 200° C. on a hotplate for 4 minutes. The paste residues are subsequently rinsed off the surface using a water jet. The etching is characterised using a tactile surface profilometer. (FIG. 3)

### Example 6

A paste prepared in accordance with Example 3 is printed onto a glass substrate coated with a layer stack consisting of SiO2/TiO2/SiO2/TiO2 and a total thickness of 280 nm in a line width of 250 μm using a screen printer by template printing (50 μm wet-film thickness). The printed sample is treated at 250° C. in a convection oven for 5 minutes. The paste residues are subsequently rinsed off the surface using a water jet. The etching is characterised using a tactile surface profilometer. (FIG. 4)

### Example 7

A paste prepared in accordance with Example 3 is printed onto a glass substrate coated with 70 nm of FTO in various line widths of 500 μm, 250 μm and 100 μm using a screen printer by template printing (50 μm wet-film thickness). The printed sample is treated at 250° C. in a convection oven for 7 minutes. The paste residues are subsequently rinsed off the surface using a water jet. The etching is characterised using a tactile surface profilometer. (FIG. 5)

### Example 8

A paste prepared in accordance with Example 3 is printed onto a polymer film substrate coated with FTO in line widths of 100 μm using a screen printer by screen printing (30 μm wet-film thickness). The printed sample is treated at 100° C. in a convection oven for 3 minutes. The paste residues are subsequently rinsed off the surface using a water jet. The etching is characterised using a tactile surface profilometer. (FIG. 6)

### EXPLANATIONS TO THE FIGURES

FIG. 1:

Pourbaix diagram for the Nb—H2O system in the absence of complexing agents (M. Pourbaix, Atlas of electrochemical equilibria in aqueous solutions. National Association of Corrosion Engineers, Houston, USA, 1966).

FIG. 2:

Step etched into an Nb2O5 layer present on a glass plate. The average step height relative to the untreated surface is 25 nm.

FIG. 3:

The Nb2O5 and SiO2 layers present on a glass plate are etched completely.

FIG. 4:

The TiO2 and SiO2 layers present on a glass plate are etched completely.

FIG. 5:

The FTO layer present on a glass plate is etched completely.

FIG. 6:

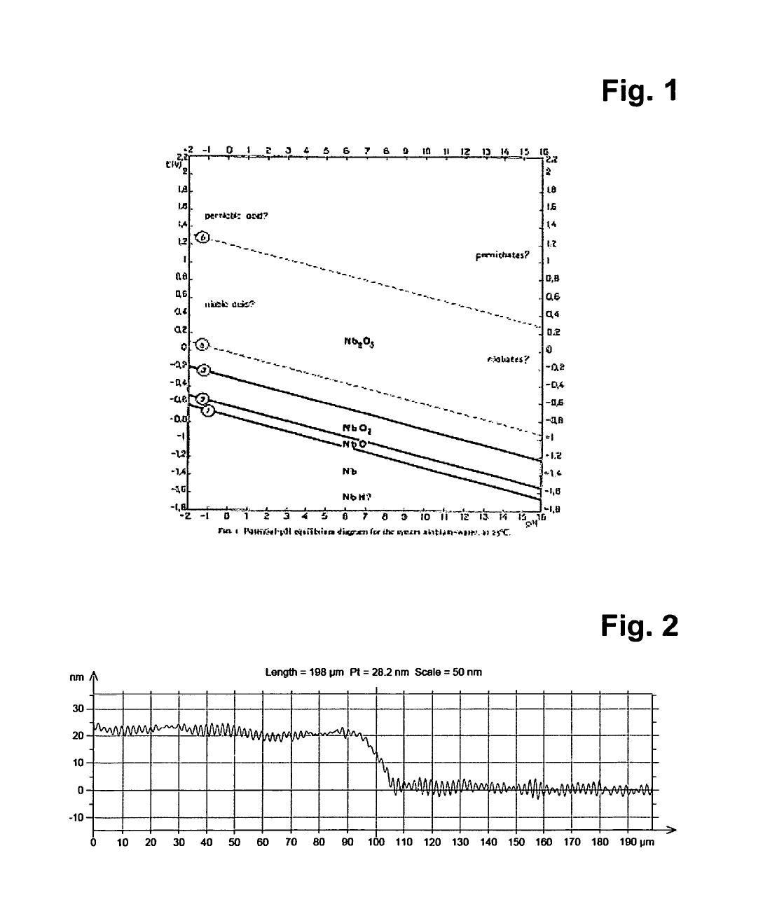

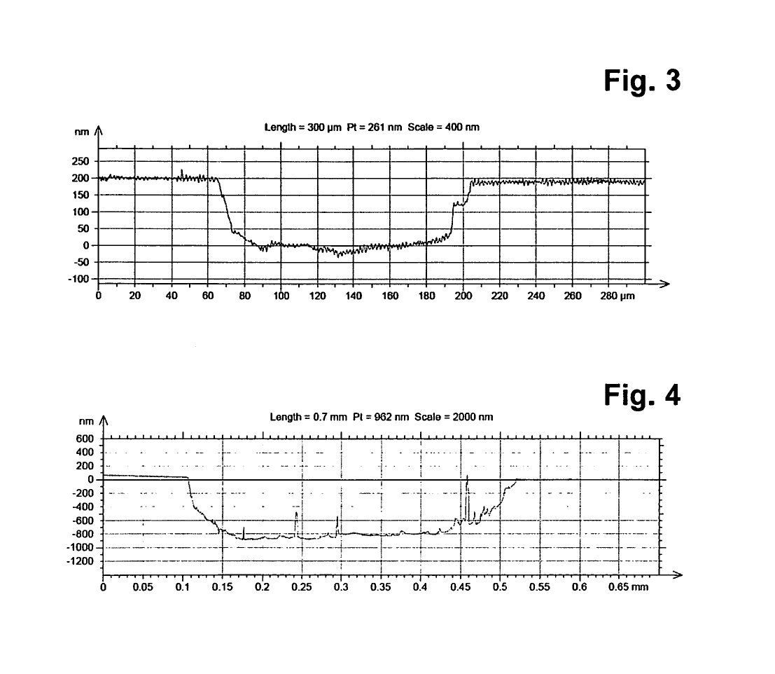

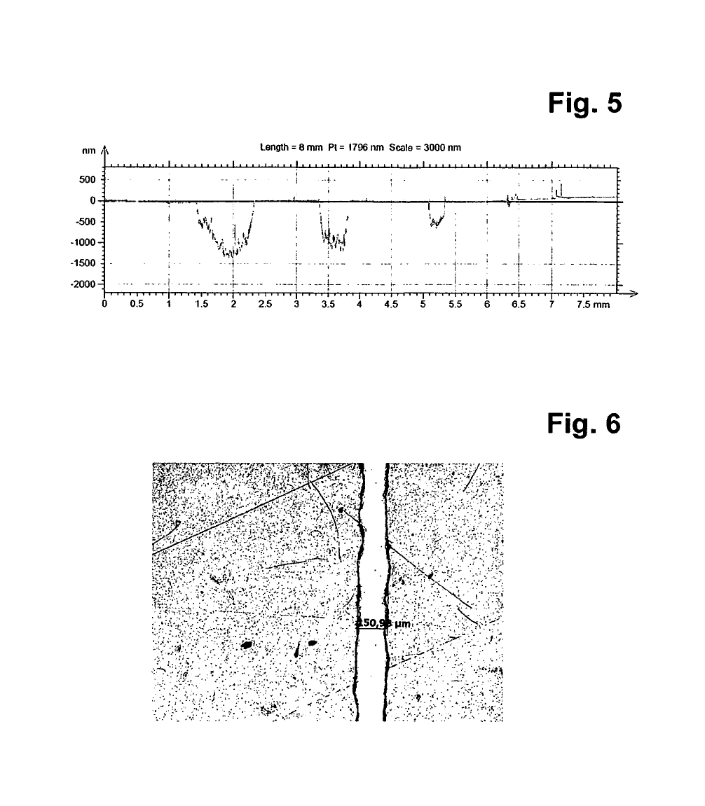

The FTO layer present on a polymer film is etched completely. Conductivity can no longer be detected in the etched region.

1. Process for the etching and structuring of antistatic coatings and of antireflection coatings, and of corresponding oxidic, transparent layer stacks, characterised in that an alkaline etching composition is applied selectively to the surface to be treated, the etching composition is activated by the input of energy, and, when the etching is complete, residues of the etching composition are removed using solvents, preferably using water.

2. Process according to claim 1, characterised in that an alkaline etching composition is applied selectively to the surface to be treated, consisting of Nb₂O₅ and Nb₂O₅/SiO₂, SiO₂/TiO₂ or fluorine-doped tin oxide (FTO), ITO (indium tin oxide), and these layers, optionally stacked layers, are etched in one step without the underlying substrate being etched at the same time.

3. Process according to claim 1, characterised in that an alkaline etching composition is applied selectively to an oxidic, transparent layer stack surface to be treated, and the layer stack is etched in one step.

4. Process according to claim 1, characterised in that an alkaline etching paste having a viscosity in the range from 5 to 100 Pa*s, preferably 5 to 50 Pa·s, is used at a shear rate of 25 s⁻¹, and applied to the surfaces to be etched by the dispenser technique or screen printing.

5. Process according to claim 1, characterised in that the etching step is carried out at a temperature in the range from 80 to 270° C., particularly preferably in the range from 100 to 250° C.

6. An etching composition adapted for use in a process according to claim 1 which comprises an alkaline etchant selected from the group KOH and NaOH and has a non-Newtonian flow behaviour.

7. An etching composition according to claim 6 which comprises an alkaline etchant in an amount of 30 to 45% by weight, preferably in an amount of 33 to 40% by weight, particularly preferably in an amount of 35 to 37% by weight.

8. An etching composition according to claim 6 which comprises solvents in an amount of 30 to 70% by weight, preferably in an amount of 35 to 65% by weight, particularly preferably in an amount of 53-62% by weight.

9. An etching composition according to claim 6 which comprises thickeners in an amount of 1 to 20% by weight, preferably in an amount of 1 to 15% by weight, particularly preferably in an amount of 1-10% by weight.
